(19) United States
(12) Patent Application Publication
(10) Pub. No.: US 2010/0000678 A1
(43) Pub. Date: Jan. 7, 2010

(54) METHOD OF MANUFACTURING PRINTED CIRCUIT BOARD BASE SHEET

(75) Inventors: Kyouyuu JO, Osaka (JP); Yasufumi MIYAKE, Osaka (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: NITTO DENKO CORPORATION, Osaka (JP)

(21) Appl. No.: 12/482,553

(22) Filed: Jun. 11, 2009

(30) Foreign Application Priority Data
Jul. 7, 2008 (JP) 2008-177135

(51) Int. Cl. B32B 37/10

(52) U.S. Cl. 156/324

(57) ABSTRACT

A combined metal layer and a protective film are arranged on one surface side of an insulating layer, and a combined metal layer and a protective film are arranged on the other surface side of the insulating layer. These layers are overlapped one another to be passed between a pair of laminating rollers. In this case, a temperature with which the combined metal layers are heated by the laminating rollers is adjusted to not less than 300° C. and not more than 360° C. A time period during which the combined metal layers are heated by the laminating rollers is adjusted to not less than 0.1 second and not more than 0.8 second.

### BACKGROUND OF THE INVENTION

1. Field of the Invention

The present invention relates to a method of manufacturing a printed circuit board base sheet.

2. Description of the Background Art

In recent years, electronic equipment such as digital appliances and cellular phones has been increasingly sophisticated and reduced in size and weight. With the sophistication and reduction in size and weight, wiring densities of printed circuit boards provided in the electronic equipment have increased.

A printed circuit board base sheet obtained by laminating a metal layer such as a copper foil on an insulating layer such as a resin film, for example, is used in manufacture of the printed circuit board. The metal layer of the printed circuit board base sheet is etched in a predetermined pattern, thereby forming a wiring pattern.

A thinner metal layer for the printed circuit board base sheet has been demanded as the wiring pattern of the printed circuit board increases in density. The printed circuit board base sheet is manufactured by thermocompression bonding the metal layer onto the insulating layer. However, when the metal layer is produced to have a thickness of as thin as 12 μm or less, for example, wrinkles are liable to be formed in the metal layer and the metal layer is liable to be broken in manufacture of the printed circuit board base sheet.

Therefore, it has been proposed to use a laminate in which an extremely thin metal layer having a thickness of 12 μm or less, for example, is provided on a support layer made of copper, for example (hereinafter referred to as a combined metal layer) (JP 2002-292788 A, for example). The printed circuit board base sheet is easily manufactured by using the combined metal layer.

When the printed circuit board base sheet is manufactured using the foregoing combined metal layer, the insulating layer and the combined metal layer are overlapped each other with the metal layer of the combined metal layer being opposite to one surface of the insulating layer to be passed between a pair of laminating rollers with high temperature. Then, the support layer of the combined metal layer is separated from the metal layer.

Here, the support layer of the combined metal layer may be separated from the metal layer by thermal impulse immediately before the thermocompression bonding by the laminating rollers in some cases. If the thermocompression bonding of the insulating layer and the metal layer is performed in the state, a gas may enter between the insulating layer and the metal layer, resulting in poor appearance of the printed circuit board base sheet.

### SUMMARY OF THE INVENTION

An object of the present invention is to provide a method of manufacturing a printed circuit board base sheet in which poor appearance is prevented.

(1) According to an aspect of the present invention, a method of manufacturing a printed circuit board base sheet includes the steps of preparing a laminate composed of a support layer and a conductor layer, and thermocompression bonding the conductor layer of the laminate onto an insulating layer by passing the laminate and the insulating layer between a pair of heating rollers with the laminate and the insulating layer overlapped each other, wherein a temperature with which the laminate is heated by the heating rollers is not less than 300° C. and not more than 360° C., and a time period during which the laminate is heated by the heating rollers is not less than 0.1 second and not more than 0.8 second in the step of thermocompression bonding the conductor layer of the laminate onto the insulating layer.

In this manufacturing method, the heating temperature of the laminate is not less than 300° C. and the heating time period is not less than 0.1 second in the thermocompression bonding, so that the surface of the insulating layer is melted to allow the insulating layer and the conductor layer of the laminate to be reliably bonded to each other when a surface of the insulating layer is thermoplastic.

In addition, at the time of the thermocompression bonding, the heating temperature of the laminate is not more than 360° C. and the heating time period is not more than 0.8 second, thereby preventing the support layer of the laminate and the conductor layer from being separated from each other by thermal impulse. This prevents gas from entering between the insulating layer and the conductor layer. As a result, poor appearance of the printed circuit board base sheet can be prevented.

(2) A resin layer may be arranged between the support layer of the laminate and one of the heating rollers in the step of thermocompression bonding the conductor layer of the laminate onto the insulating layer.

In this case, a load applied from the heating roller to the laminate is relieved by the resin layer. Moreover, the laminate is heated with not less than 300° C. by the heating roller, thereby sufficiently reducing the modulus of elasticity of the insulating layer. Thus, the load applied from the heating roller to the laminate is more sufficiently relieved by the resin layer.

(3) The insulating layer may include polyimide. In this case, the modulus of elasticity of the insulating layer is sufficiently reduced at the time of the thermocompression bonding. This relieves a load applied from the insulating layer to the laminate. Moreover, when the surface of the insulating layer is made of thermoplastic polyimide, the surface of the insulating layer is reliably melted at the time of the thermocompression bonding, and the conductor layer of the laminate is bonded onto the insulating layer with sufficient strength.

This more reliably prevents poor appearance of the printed circuit board base sheet.

(4) The conductor layer may include copper. In this case, gas is reliably prevented from entering between the insulating layer and the conductor layer at the time of the thermocompression bonding. Thus, poor appearance of the printed circuit board base sheet is reliably prevented.

According to the present invention, the conductor layer of the laminate can be bonded onto the insulating layer with sufficient strength, and poor appearance of the printed circuit board base sheet can be prevented.

Other features, elements, characteristics, and advantages of the present invention will become more apparent from the following description of preferred embodiments of the present invention with reference to the attached drawings.

### BRIEF DESCRIPTION OF THE DRAWINGS

FIG. 1 is a schematic sectional view of a combined metal layer used in a method of manufacturing a printed circuit board base sheet according to the present embodiment.

FIG. 2 is a schematic sectional view showing the outline of the method of manufacturing the printed circuit board using the combined metal layer.

FIG. 3 is a schematic sectional view showing the outline of the method of manufacturing the printed circuit board using the combined metal layer.

FIG. 4 is a schematic side view for explaining details of a step of laminating combined metal layers and protective films on an insulating layer.

### DESCRIPTION OF THE PREFERRED EMBODIMENTS

Hereinafter, description is made of a method of manufacturing a printed circuit board base sheet according to one embodiment of the present invention while referring to the drawings.

(1) Combined Metal Layer

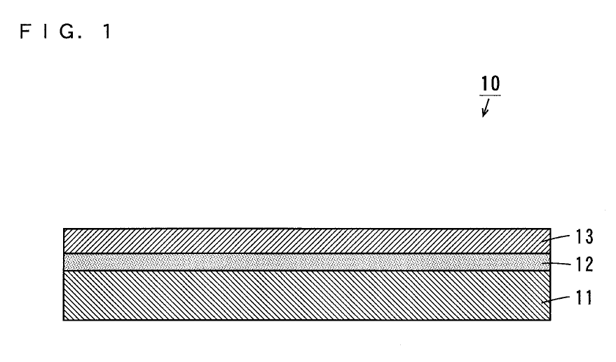

FIG. 1 is a schematic sectional view of a combined metal layer used in the method of manufacturing the printed circuit board base sheet according to the present embodiment.

As shown in FIG. 1, the combined metal layer 10 has a structure in which a metal layer 13 is laminated on a support layer 11 with a release layer 12 sandwiched therebetween. The support layer 11 and the metal layer 13 are made of a metal material such as an electrolytic copper foil. The thickness of the support layer 11 is not less than 10 μm and not more than 150 μm, for example, and preferably not less than 15 μm and not more than 100 μm. The thickness of the metal layer 13 is not more than 9 μm, for example, and preferably not less than 1 μm and not more than 5 μm.

The release layer 12 includes a first diffusion prevention layer, a release function layer and a second diffusion prevention layer. The first diffusion prevention layer is arranged on the support layer 11 side, the second diffusion prevention layer is arranged on the metal layer 13 side, and the release function layer is arranged between the first and second diffusion prevention layers.

The first and second diffusion prevention layers each include a heat-resistant alloy made of nickel (Ni) and phosphorus (P), for example. The release function layer includes a metal oxide of nickel, chromium (Cr), Molybdenum (Mo) or the like, for example. The first and second diffusion prevention layers prevent diffusion of metal atoms included in the support layer 11 and the metal layer 13. The release function layer holds the metal layer 13 in a releasable manner.

The thickness of the first diffusion prevention layer of the release layer 12 is not less than 0.005 μm and not more than 5 μm, for example, and preferably not less than 0.01 μm and not more than 1 μm. The thickness of the release function layer of the release layer 12 is as extremely thin as several angstroms to several dozen angstroms, for example. The thickness of the second diffusion prevention layer of the release layer 12 is not less than 0.005 μm and not more than 5 μm, for example, and preferably not less than 0.01 μm and not more than 1 μm.

(2) Manufacture of Printed Circuit Board Base Sheet

(2-1) Outline

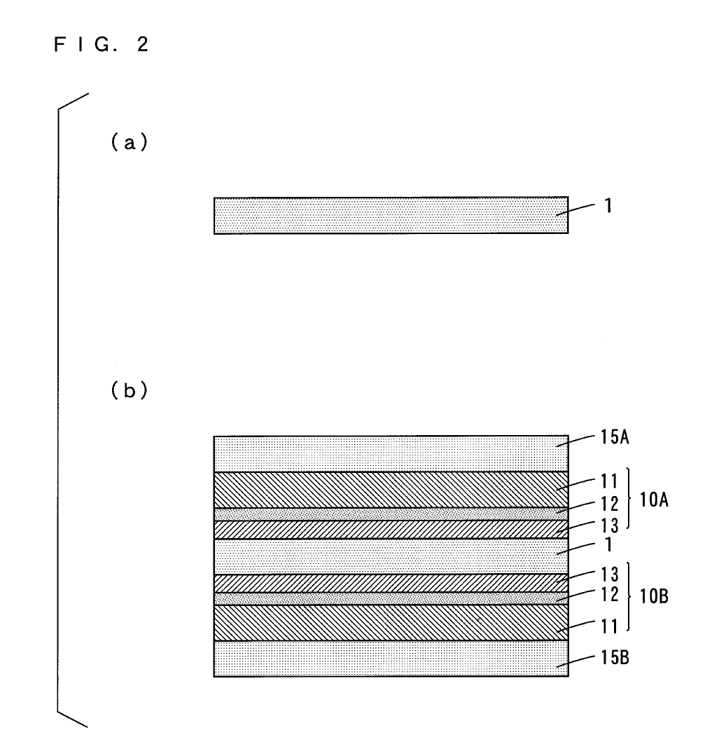

Next, description is made of a method of manufacturing a printed circuit board base sheet using the foregoing combined metal layer 10. FIG. 2 is a schematic sectional view showing the outline of the method of manufacturing the printed circuit board using the combined metal layer 10.

First, an insulating layer 1 made of polyimide is prepared as shown in FIG. 2(a). The insulating layer 1 has a structure in which thermoplastic polyimide layers are arranged on one surface side and the other surface side, and a thermosetting polyimide film is sandwiched therebetween. The thickness of the thermosetting polyimide film of the insulating layer 1 is not less than 5 μm and not more than 50 μm, for example, and preferably not less than 7 μm and not more than 38 μm. The thickness of each of the thermoplastic polyimide layers is not less than 0.5 μm and not more than 3 μm, for example, and preferably not less than 1 μm and not more than 2.5 μm.

Next, a combined metal layer 10A and a protective film 15A made of polyimide, for example, are laminated on the one surface of the insulating layer 1 as shown in FIG. 2(b). In addition, a combined metal layer 10B and a protective film 15B made of polyimide, for example, are laminated on the other surface of the insulating layer 1. The combined metal layers 10A, 10B each have the same structure as that of the combined metal layer 10 shown in FIG. 1.

In this case, the metal layers 13 of the combined metal layers 10A, 10B are laminated on the one surface and the other surface of the insulating layer 1, respectively, and the protective films 15A, 15B are laminated on the support layers 11 of the combined metal layers 10A, 10B, respectively. The thickness of each of the protective films 15A, 15B is preferably not less than 75 μm. When the thickness of each of the protective films 15A, 15B is less than 75 μm, buffering effects at the time of lamination and protecting effects of the combined metal layers 10A, 10B are not sufficiently obtained.

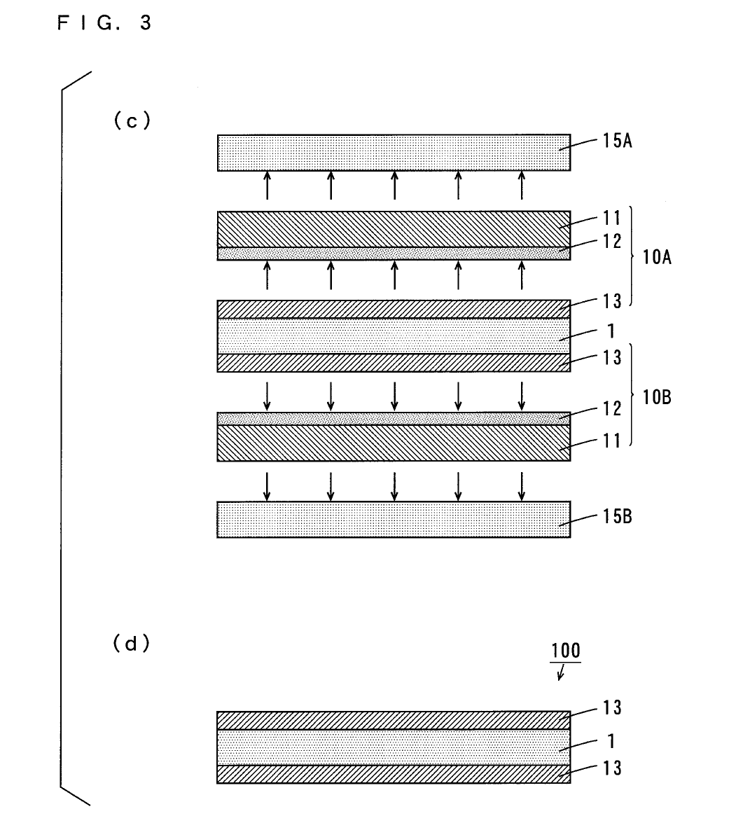

Next, the protective film 15A is separated from the support layer 11 of the combined metal layer 10A and the support layer 11 of the combined metal layer 10A is separated with the release layer 12 from the metal layer 13 on the one surface side of the insulating layer 1 as shown in FIG. 3(c). In addition, the protective film 15B is separated from the support layer 11 of the combined metal layer 10B and the support layer 11 of the combined metal layer 10B is separated with the release layer 12 from the metal layer 13 on the other surface side of the insulating layer 1. In this manner, the printed circuit board base sheet 100 is completed as shown in FIG. 3 (d).

The metal layers 13 on the one surface and the other surface of the printed circuit board base sheet 100 are etched in predetermined patterns, thereby forming a wiring pattern and a ground pattern. Thus, the printed circuit board is produced.

(2-2) Lamination

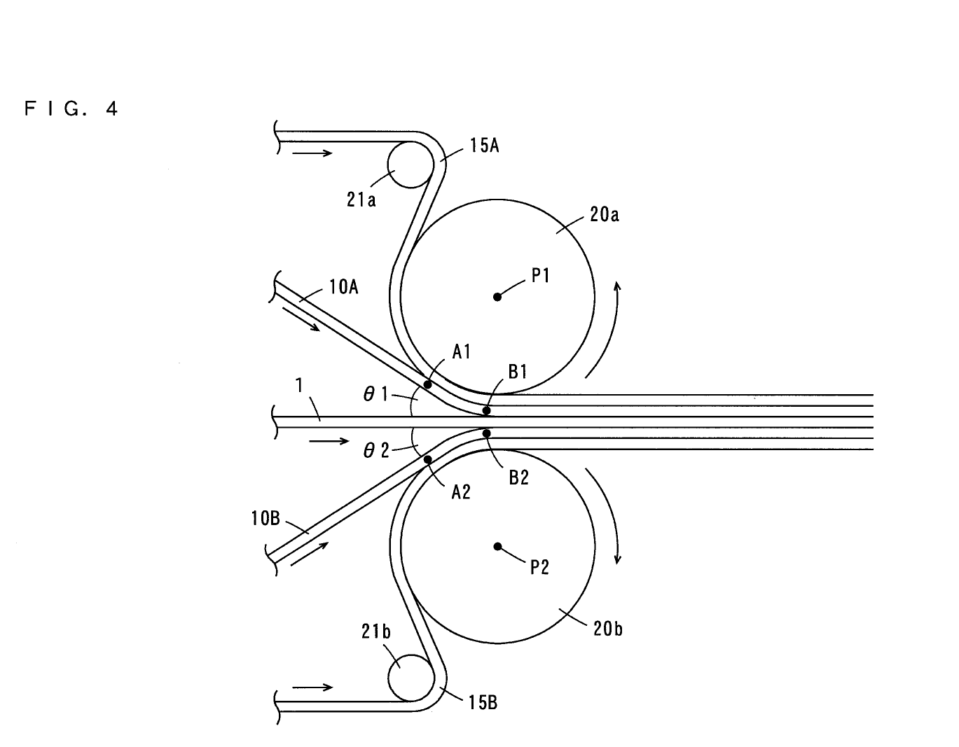

Next, description is made of a step of laminating the combined metal layers 10A, 10B and the protective films 15A, 15B on the insulating layer 1 shown in FIG. 2(b). FIG. 4 is a schematic side view for explaining details of the step of laminating the combined metal layers 10A, 10B and the protective films 15A, 15B on the insulating layer 1.

As shown in FIG. 4, the combined metal layer 10A and the protective film 15A are arranged on the one surface side of the insulating layer 1, and the combined metal layer 10B and the protective film 15B are arranged on the other surface side of the insulating layer 1. Note that the protective films 15A, 15B are carried by carrier rollers 21a, 21b, respectively. The insulating layer 1 and the combined metal layers 10A, 10B are carried by carrier rollers (not shown), respectively. Then, theses layers that are overlapped each other are passed between a pair of laminating rollers 20a, 20b.

Thus, the combined metal layers 10A, 10B and the protective films 15A, 15B are thermocompression bonded to the one surface side and the other surface side of the insulating layer 1, respectively. In this case, the protective films 15A, 15B are arranged between the combined metal layers 10A, 10B and the laminating rollers 20a, 20b, respectively, so that loads applied from the laminating rollers 20a, 20b to the combined metal layers 10A, 10B can be relieved.

In the present embodiment, a heating temperature with which the combined metal layers 10A, 10B are heated by the laminating rollers 20a, 20b is adjusted to not less than 300° C. and not more than 360° C. Here, the heating temperature of the combined metal layers 10A, 10B is a temperature of surfaces of the laminating rollers 20a, 20b.

Moreover, a heating time period during which the combined metal layers 10A, 10B are heated by the laminating rollers 20a, 20b is adjusted to not less than 0.1 second and not more than 0.8 second. Here, the heating time period of the combined metal layers 10A, 10B is a time period during which arbitrary one points of the combined metal layers 10A, 10B are in contact with the laminating rollers 20a, 20b with the protective films 15A, 15B sandwiched therebetween, respectively.

Specifically, the combined metal layer 10A comes into contact with a surface of the protective film 15A on an outer peripheral surface of the laminating roller 20a at a position A1 in FIG. 4. At a position B1, the protective film 15A laminated on the combined metal layer 10A starts to move away from the laminating roller 20a. In this case, a time period required for the combined metal layer 10A to move from the position A1 to the position B1 corresponds to the heating time period of the combined metal layer 10A.

Similarly, the combined metal layer 10B comes into contact with a surface of the protective film 15B on an outer peripheral surface of the laminating roller 20b at a position A2 in FIG. 4. At a position B2, a portion of the protective film 15B in contact with the combined metal layer 10B starts to move away from the laminating roller 20b. That is, a time period required for the combined metal layer 10B to move from the position A2 to the position B2 is the heating time period of the combined metal layer 10B.

The heating time period of the combined metal layers 10A, 10B changes depending on the size of the laminating rollers 20a, 20b, the rotation speed of the laminating rollers 20a, 20b, the angles θ1, θ2 between the combined metal layers 10A, 10B and the insulating layer 1, and so on. Note that the insulating layer 1 is arranged vertically to a straight line connecting axial centers P1, P2 of the laminating rollers 20a, 20b in FIG. 4.

(3) Effects

In the present embodiment, the heating temperature of the combined metal layers 10A, 10B is adjusted to not less than 300° C. and not more than 360° C., and the heating time period of the combined metal layers 10A, 10B is adjusted to not less than 0.1 second and not more than 0.8 second in the step of laminating the combined metal layers 10A, 10B and the protective films 15A, 15B on the insulating layer 1.

In this case, the heating temperature of the combined metal layers 10A, 10B is not less than 300° C. and the heating time period of the combined metal layers 10A, 10B is not less than 0.1 second, so that the thermoplastic polyimide layers of the insulating layer 1 can be reliably melted to cause the insulating layer 1 and the metal layers 13 of the combined metal layers 10A, 10B to be bonded to one another with sufficient strength. Furthermore, the moduli of elasticity of the insulating layer 1 and the protective films 15A, 15B can be suitably decreased, and therefore the loads applied from the laminating rollers 20a, 20b to the combined metal layers 10A, 10B can be sufficiently relieved.

In addition, the heating temperature of the combined metal layers 10A, 10B is not more than 360° C. and the heating time period of the combined metal layers 10A, 10B is not more than 0.8 second, so that the support layers 11 of the combined metal layers 10A, 10B are prevented from being separated from the metal layers 13 by thermal impulse before reaching the positions B1, B2 of FIG. 4. Accordingly, gas is prevented from entering between the insulting layer 1 and the metal layers 13 at the time of the thermocompression bonding by the laminating rollers 20a, 20b.

In this manner, the metal layers 13 of the combined metal layers 10A, 10B can be well laminated on the both surfaces of the insulating layer 1, and poor appearance of the printed circuit board base sheet 100 can be prevented.

(4) Inventive Examples and Comparative Examples

The combined metal layers 10A, 10B and the protective films 15A, 15B were laminated on the insulating layer 1 with the heating temperature and the heating time period of the combined metal layers 10A, 10B set to various values to produce the printed circuit board base sheet 100.

Table 1 shows the heating temperature of the combined metal layers 10A, 10B, the rotation speed of the laminating rollers 20a, 20b, the angles θ1, θ2 in FIG. 4, the length from the positions A1, A2 to B1, B2 in FIG. 4, and a set value of the heating time period of the combined metal layers 10A, 10B in each of the inventive examples 1 to 8 and the comparative examples 1 to 4.

TABLE 1

| | | | | LENGTH | | |
|---|---|---|---|---|---|---|
| | | | | FROM | | |
| | | | | POSITIONS | | |
| | | | | A1, A2 TO | HEATING | |
| | HEATING | ROTATION | ANGLES | POSITIONS | TIME | |
| | TEMPERATURE | SPEED | θ1, θ2 | B1, B2 | PERIOD | |
| No. | (° C.) | (m/min) | (°) | (mm) | (sec) | APPEARANCE |
| INVENTIVE | 300 | 1.0 | 1.36 | 4.51 | 0.3 | ◯ |
| EXAMPLE 1 | | | | | | |
| INVENTIVE | 300 | 2.0 | 1.36 | 4.51 | 0.1 | ◯ |
| EXAMPLE 2 | | | | | | |
| INVENTIVE | 320 | 0.5 | 1.36 | 4.51 | 0.5 | ◯ |
| EXAMPLE 3 | | | | | | |
| INVENTIVE | 320 | 1.0 | 1.36 | 4.51 | 0.3 | ◯ |
| EXAMPLE 4 | | | | | | |
| INVENTIVE | 320 | 2.0 | 1.36 | 4.51 | 0.1 | ◯ |
| EXAMPLE 5 | | | | | | |
| INVENTIVE | 320 | 2.0 | 7.99 | 26.50 | 0.8 | ◯ |
| EXAMPLE 6 | | | | | | |
| INVENTIVE | 340 | 1.0 | 1.36 | 4.51 | 0.3 | ◯ |
| EXAMPLE 7 | | | | | | |
| INVENTIVE | 360 | 2.0 | 1.36 | 4.51 | 0.1 | ◯ |
| EXAMPLE 8 | | | | | | |
| COMPARATIVE | 280 | 1.0 | 1.36 | 4.51 | 0.3 | X |
| EXAMPLE 1 | | | | | | |
| COMPARATIVE | 290 | 1.0 | 1.36 | 4.51 | 0.3 | X |
| EXAMPLE 2 | | | | | | |
| COMPARATIVE | 360 | 1.0 | 7.99 | 26.50 | 1.6 | X |
| EXAMPLE 3 | | | | | | |
| COMPARATIVE | 370 | 2.0 | 3.79 | 12.57 | 0.4 | X |
| EXAMPLE 4 | | | | | | |

Note that the laminating rollers 20a, 20b each having the diameter of 380 mm were used. In addition, the combined metal layers 10A, 10B having the support layers 11 and the metal layers 13 made of electrolytic copper and the protective films 15A, 15B made of polyimide were used.

The thickness of the thermosetting polyimide layer was 14 μm, and the thickness of each of the thermoplastic polyimide layers was 2 μm in the insulating layer 1. The thickness of each of the support layers 11 was 18 μm, the thickness of each of the release layers 12 was 0.015 μm, and the thickness of each of the metal layers 13 was 2 μm in the combined metal layers 10A, 10B.

(4-1) Inventive Examples

In the inventive examples 1 to 8, the heating temperature of the combined metal layers 10A, 10B was set in a range from 300° C. to 360° C. The rotation speed of the laminating rollers 20a, 20b, the angles θ1, θ2, the length from the positions Al, A2 to the positions B1, B2 were adjusted such that the heating time period of the combined metal layers 10A, 10B was 0.1 to 0.8 second.

(4-2) Comparative Examples

The heating temperatures of the combined metal layers 10A, 10B were set to 280° C. and 290° C. in the comparative examples 1, 2, respectively, and the heating time period was set to 0.3 second both in the comparative examples 1, 2. The heating temperatures of the combined metal layers 10A, 10B were set to 360° C. and 370° C., respectively, and the heating time periods were set to 1.6 seconds and 0.4 second, respectively, in the comparative examples 3, 4.

(4-3) Evaluation

Table 1 shows whether the appearance of the printed circuit board base sheet 100 produced in the inventive examples and the comparative examples 1 to 4 was good or bad.

In the inventive examples 1 to 8, the metal layers 13 of the combined metal layers 10A, 10B were well laminated on the both surfaces of the insulating layer 1, and the appearance of the produced printed circuit board base sheet 100 was not ruined.

Meanwhile, the moduli of elasticity of the insulating layer 1 and the protective films 15A, 15B were not sufficiently decreased, and the loads applied from the laminating rollers 20a, 20b to the combined metal layers 10A, 10B were not sufficiently relieved in the comparative examples 1, 2. In addition, the moduli of elasticity of the protective films 15A, 15B were high, so that pressure was not equally applied on the combined metal layers 10A, 10B and the insulating layer 1. As a result, the appearance of the produced printed circuit board base sheet 100 was ruined.

In the comparative examples 3, 4, the support layers 11 of the combined metal layers 10A, 10B were separated from the metal layers 13 by thermal impulse before the combined metal layers 10A, 10B reached the positions B1, B2 of FIG. 4. Thus, gas entered between the insulating layer 1 and the metal layers 13, and the appearance of the produced printed circuit board base sheet 100 was ruined.

The results show that the metal layers 13 of the combined metal layers 10A, 10B can be well laminated on the both surfaces of the insulating layer 1 to prevent poor appearance of the printed circuit board base sheet 100 by setting the heating temperature of the combined metal layers 10A, 10B to not less than 300° C. and not more than 360° C. and setting the heating time period of the combined metal layers 10A, 10B to not less than 0.1 second and not more than 0.8 second in the step of laminating the combined metal layers 10A, 10B and the protective films 15A, 15B on the insulating layer 1.

(5) Other Embodiments

While the metal layers 13 are laminated on the both surfaces of the insulating layer 1 in the above-described embodiment, the metal layer 13 may be laminated only on one surface of the insulating layer 1.

While the protective films 15A, 15B were used for relieving the loads applied from the laminating rollers 20a, 20b to the combined metal layers 10A, 10B in the above-described embodiment, the protective films 15A, 15B may not be used if the loads applied from the laminating rollers 20a, 20b to the combined metal layers 10A, 10B can be sufficiently relieved. In this case, a time period during which arbitrary one points of the combined metal layers 10A, 10B are in direct contact with the laminating rollers 20a, 20b corresponds to the heating time period of the combined metal layers 10A, 10B.

Another insulating material such as epoxy resin may be used as the insulating layer 1 instead of polyimide. Non-thermoplastic plastic with heat resistance that is not melted at the heating temperature in the lamination may be used as the protective films 15A, 15B instead of polyimide. Another metal such as gold (Au) and aluminum or an alloy such as a copper alloy and an aluminum alloy, not limited to copper, may be used as the support layers 11 or the metal layers 13 of the combined metal layers 10A, 10B.

(6) Correspondences between Elements in the Claims and Parts in Embodiments

In the following paragraph, non-limiting examples of correspondences between various elements recited in the claims below and those described above with respect to various preferred embodiments of the present invention are explained.

In the foregoing embodiments, the combined metal layers 10A, 10B are examples of a laminate, the metal layer 13 is an example of a conductor layer, the laminating rollers 20a, 20b are examples of a heating roller, and the protective films 15A, 15B are examples of a resin layer.

As each of various elements recited in the claims, various other elements having configurations or functions described in the claims can be also used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A method of manufacturing a printed circuit board base sheet comprising the steps of:
preparing a laminate composed of a support layer and a conductor layer; and
thermocompression bonding said conductor layer of said laminate onto an insulating layer by passing said laminate and said insulating layer between a pair of heating rollers with said laminate and said insulating layer overlapped each other, wherein
a temperature with which said laminate is heated by said heating rollers is not less than 300° C. and not more than 360° C., and a time period during which said laminate is heated by said heating rollers is not less than 0.1 second and not more than 0.8 second in the step of thermocompression bonding said conductor layer of said laminate onto said insulating layer.

2. The method of manufacturing the printed circuit board base sheet according to claim 1, wherein a resin layer is arranged between said support layer of said laminate and one of said heating rollers in the step of thermocompression bonding said conductor layer of said laminate onto said insulating layer.

3. The method of manufacturing the printed circuit board base sheet according to claim 1, wherein said insulating layer includes polyimide.

4. The method of manufacturing the printed circuit board base sheet according to claim 1, wherein said conductor layer includes copper.
